(19) United States
(12) Patent Application Publication
(10) Pub. No.: US 2003/0187857 A1
(43) Pub. Date: Oct. 2, 2003

(54) Computer resource access system and method

(76) Inventor: Daniel E. Ford, Granite Bay, CA (US)

Correspondence Address: HEWLETT-PACKARD COMPANY, Intellectual Property Administration, P.O. Box 272400, Fort Collins, CO, 80527-2400, US

(21) Appl. No.: 10/113,169

(22) Filed: Mar. 29, 2002

(51) Int. Cl. G06F 7/00

(52) U.S. Cl. 707/100

(57) ABSTRACT

One embodiment according to the present invention is a computer resource access system and method for use with a computer system. The system comprises a data structure [38] residing in computer memory [24] accessible to the computer system, and a reference residing in the data structure as a reference entry. The reference provides access to a computer resource required by a computer application, and the reference entry has an associated lifetime. The data structure [38] is operable to remove the reference entry based on the associated lifetime. The method comprises populating a data structure [38] with at least one reference as a reference entry, and removing the reference entry based on an associated lifetime. The data structure resides in memory [24] accessible to the computer system, and the associated lifetime is associated with the reference entry. The reference provides access to a computer resource of the computer system.

### FIELD OF THE INVENTION

The present invention relates generally to computer resource access systems and to self-pruning data structures in particular.

### BACKGROUND OF THE INVENTION

There is considerable interest today in computer resource management, particularly with regard to networked computer systems running distributed applications. Some computing tools have been developed in years past to assist in management of computer resources. These tools, however, fail to adequately address the needs of computer systems in general and of computer network systems running distributed applications in particular.

One example of such tools are caches and caching systems and methods. A simple cache example involves the management of on-board computer memory, known as the level one cache, and disk memory, sometimes known as level two cache. The level one cache is fast, but expensive and therefore small. The level two cache is slower but less expensive, and therefore large. Simple caching generally involves retention of most recently accessed data on disk in the level one cache, on the theory that it is most likely to be required again in the near future. The reference table used to manage the level one cache generally operates on a first-in/first-out basis, like a queue, but one skilled in the art will readily appreciate that various methods for managing the level one cache have been employed over the years. It is common practice, for example, to replace a reference at the end of the queue each time it is used, and also to make certain oft-used references “sticky” so as to never be removed from the reference table.

These caching systems and methods, however, do not adequately address the needs of computer network systems running distributed applications. For example, a first-in/first-out reference table for accessing connections of a distributed application in a computer network potentially drops a connection to one client that needs more time to communicate than another, due to rate of connection. The result could be maintenance of a connection to a departed client in favor of one still trying to use the distributed application. Similarly, a connection to a client may not be dropped as quickly as desirable if the reference has to be the oldest reference in the table to be dropped. In a related manner, one application running on a computer network may need its references to cached information from disk to remain longer than those of another application, and a first-in/first-out method does not accommodate that need. Furthermore, the first-in/first-out method fails to accommodate an application that may wish to veto removal of a reference from the table. Thus, the need exists for a reference table that can prune itself based on an age of the contents that more accurately reflects the needs of applications.

As an example of a data structure that prunes itself, the WeakHashMap supplied with the Java programming language is a data structure that contains only weak references to objects. Weak references do not prevent garbage collection of the referenced object, and it is thus possible to utilize such a table to permit applications to reference objects and data without having to worry about incrementing and decrementing a reference count. The WeakHashMap, however, cannot hold the objects in memory and prunes itself by removing references after garbage collection based on the reference queue used by the garbage collector. The WeakHashMap, thus, retains references to objects that may no longer exist, and does nothing to keep the resources it references from being garbage collected. Hence, previously developed tools remain unsuitable to serve in the capacity of managing computer resources, particularly where those computer resources are required by distributed applications running over a computer network. Providing a suitable tool remains the task of one embodiment of the present invention.

### SUMMARY OF THE INVENTION

In a first aspect, a computer resource access system for use with a computer system comprises a data structure residing in computer memory accessible to the computer system, and a reference residing in the data structure as a reference entry. The reference provides access to a computer resource required by a computer application, wherein the reference entry has an associated lifetime. The data structure is operable to remove the reference entry based on the associated lifetime.

In a second aspect, a computer resource access method for use with a computer system comprises populating a data structure with at least one reference as a reference entry, wherein the data structure resides in memory accessible to the computer system. The reference further provides access to a computer resource of the computer system, wherein the computer resource is required by an application. The method further comprises removing the reference entry based on an associated lifetime, wherein the associated lifetime is associated with the reference entry.

In a third aspect, a data management system for use with a data structure stored in memory accessible to a data processing system is operable to traverse the data structure, wherein the data structure is organized into entries having associated lifetimes. The system is further operable to make an examination regarding the associated lifetimes, and to remove entries based on the examination.

Further areas of applicability will become apparent from the detailed description provided hereinafter. It should be understood that the detailed description and specific examples, while indicating one or more embodiments of the invention, are intended for purposes of illustration only and are not intended to limit the scope of the invention.

### BRIEF DESCRIPTION OF THE DRAWINGS

Various embodiments of the present invention will become more fully understood from the detailed description and the accompanying drawings, wherein:

FIG. 1 is a diagram of an exemplary implementation of one embodiment in accordance with the present invention for managing connections of distributed applications in a networked computer system.

FIG. 2 is a diagram of an exemplary implementation of one embodiment of the present invention for providing speedy access to recently accessed data normally stored on disk according to requirements of a particular application.

FIG. 3 is a flow-chart diagram depicting an exemplary method of operation for use with one embodiment of the present invention.

### DETAILED DESCRIPTION OF EMBODIMENTS IN ACCORDANCE WITH THE PRESENT INVENTION

The following description of embodiment(s) is merely exemplary in nature and is in no way intended to limit the invention, its application, or uses. As will be readily understood by those skilled in the art, various embodiments in accordance with the present invention may be implemented in a number of ways.

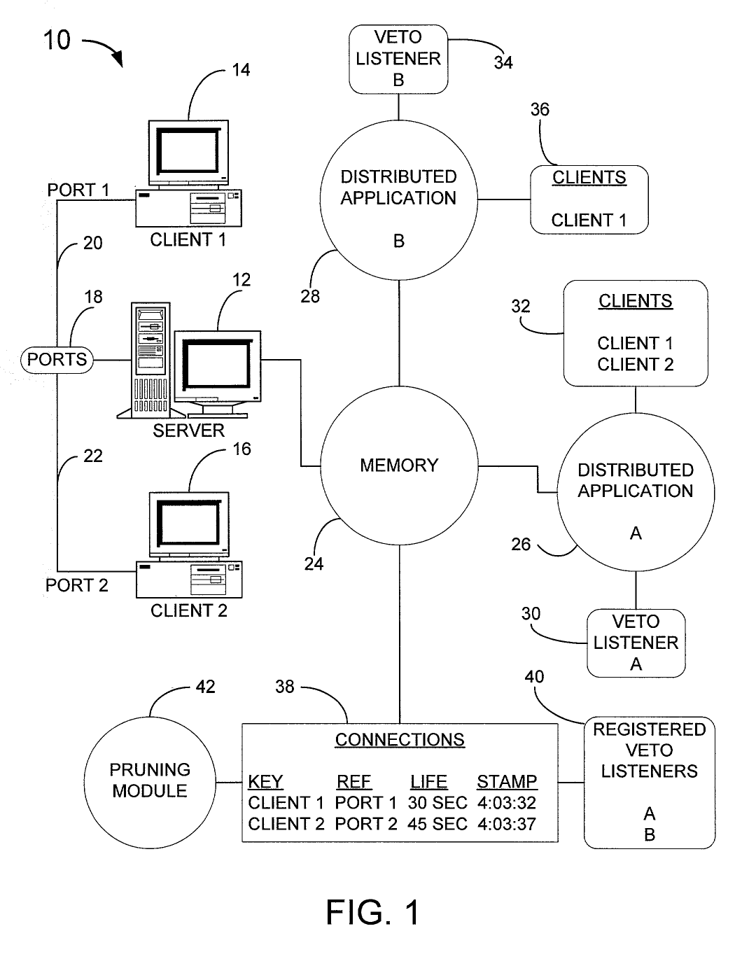

Referring to FIG. 1, a distributed connection management system 10 is shown. A server 12 communicates with a first client 14 (Client 1) and a second client 16 (Client 2) via port 18. Server 12 communicates with first client 14 via port 1 as shown at 20, and server 12 communicates with the second client 16 via port 2 as shown at 22. A memory 24 accessible to the server 12 is likewise accessible to a distributed application A 26 and a distributed application B 28. Distributed application A 26 has a veto listener A 30 and a client list A 32. Likewise, distributed application B has a veto listener B 34 and a client list B 36. Residing in memory 24 is data structure 38.

In accordance with one embodiment according to the present invention, data structure 38 features a list of registered listeners 40 and a pruning module 42. Further in accordance with one embodiment according to the present invention, data structure 38 features fields including key, reference, lifetime, and time stamp fields. Further in accordance with one embodiment according to the present invention, distributed application B 28 registers its connection with client 1 in the data structure 38. Distributed application B 28 provides the data structure 38 with information necessary to make the reference entry including the key (Client 1), the reference (port 1), and the lifetime (30 seconds). As may readily be appreciated by one skilled in the art, the lifetime 30 seconds may be desirable in the case of a reference entry for a connection with client 1 due to a speed of connection required for communication with client 1. The time stamp for the reference entry, 4:03:32, is also initialized for a current time that is a time of initialization for the reference entry. Further in accordance with one embodiment according to the present invention, distributed application B 28 registers its veto listener B 34 with the list of registered listeners 40 of data structure 38.

Further in accordance with one embodiment according to the present invention, distributed application A 26, seeks to communicate with the clients, Client 1 and Client 2, in its client list A 32. Distributed application A 26 is adapted to reference connections with the clients in its client list A 32 via data structure 38. Seeking to communicate with client 1, distributed application A 26 seeks to reference the connection with client 1 via data structure 38 and finds the reference entry keyed by Client 1 pointing to port 1. Thus, distributed application A 26 successfully writes to port 1 via data structure 38 using the key for Client 1 kept in client list A 32. Similarly, distributed application A 26 seeks to communicate with Client 2 via data structure 38. Not finding the reference entry for Client 2 in data structure 38, distributed application A 26 registers a reference entry for connection with client 2 in data structure 38. The key for this reference entry is Client 2 while the reference is port 2 and the life time is 45 seconds. As will be readily appreciated by one skilled in the art, the 45 second lifetime for the reference entry for the connection of the Client 2 may be particularly appropriate based on a rate of connection with the second client 16. The time stamp for this reference entry is 4:30:37, which represents a current time at a time of initialization of the reference entry. Still further in accordance with one embodiment according to the present invention, distributed application B 28, registers its veto listener B 34 with the list of registered listeners 40 of data structure 38.

Further in accordance with one embodiment according to the present invention, pruning module 42 wakes up periodically and traverses data structure 38. In a preferred implementation, data structure 38 is a hash table, thus permitting the traversal to be a scan of the hash table. During the process of the scan, printing module 42 computes an elapsed time based on the associated time stamp for each reference entry and compares it to the associated lifetime for each reference entry. If the associated life time has been exceeded based on the elapsed time, printing module 42 attempts to remove the reference entry. In a manner readily appreciated by one skilled in the art, pruning module 42 notifies each of the registered veto listeners in the list of registered listeners 40 of data structure 38 regarding removal of that data entry. Thus, each distributed application that is a registered listener may veto removal of the reference entry.

If, for example, pruning module 42 wakes up at 4:04:15 and compares the current time with the time stamp associated with the first reference entry, pruning module 42 will compute an elapsed time of 32 seconds. Comparing the computed elapsed time to the associated lifetime of that reference entry, pruning module 42 determines that the associated lifetime has been exceeded for that reference entry. Thus pruning module 42, will send an eminent removal event to veto listener A 30 and veto listener B 34 by referring to the list of registered listeners 40 of data structure 38. As a result of the event received by veto listener B 34, distributed application B 28 may seek to determine if the first client 14 has died; and distributed application A 26 may behave similarly or dissimilarly in response to the event it receives. Methods known in the art for determining whether a client has died will be readily appreciated by those skilled in the art. If distributed application B 28 determines that the first client 14 has not died and wishes to maintain a good connection, distributed application B 28 may choose to veto the removal of the reference entry regarding the connection of Client 1.

Alternatively, distributed application B 28 may chose not to veto removal of the reference entry. If, for example, it has concluded business with client 1 (14) and is preparing to deregister its veto listener 34 with data structure 38, distributed application B may not wish to veto removal of the reference entry regarding the connection to Client 1. Similarly, distributed application A 26 may be aware that it is about to write to Client 1 and thus needs the reference in data structure 38 to the connection with Client 1. As a result, distribute application A 26 may chose to veto removal of the reference entry regarding the connection with Client 1. In any case, when removal of a reference entry is vetoed, the reference entry time stamp is preferably updated to reflect the current time at the time of the veto. It is also possible that a distributed application may wish to alter the lifetime associated with the reference entry, and further embodiments in accordance with the present invention may implement this functionality. This functionality may be particularly desirable, for example, if one application prefers to be called every few hours, whereas another prefers to be called every few seconds. A shared reference instantiated by the application that prefers to be called every few seconds may then prove an annoyance to the application that prefers to be called every few hours. Thus, the application that prefers to be called every few hours may wish to alter the associated lifetime for that reference entry.

Further in accordance with one embodiment according to the present invention, it may be desirable to update the time stamp associated with a particular reference entry each time a distributed application accesses a connection with a client via the reference entry. In such a case, in the preceding example when distributed application A 26 refers to the connection with client 1 via data structure 38, the time stamp associated with that reference entry would have been updated to affect the current time 4:03:37. It may also be desirable to provide a default lifetime for a reference entry where a lifetime is not specified for that reference entry by a distributed application. As will be readily appreciated by one skilled in the art, present invention may be readily adapted to other uses than a distributed connection management system 10.

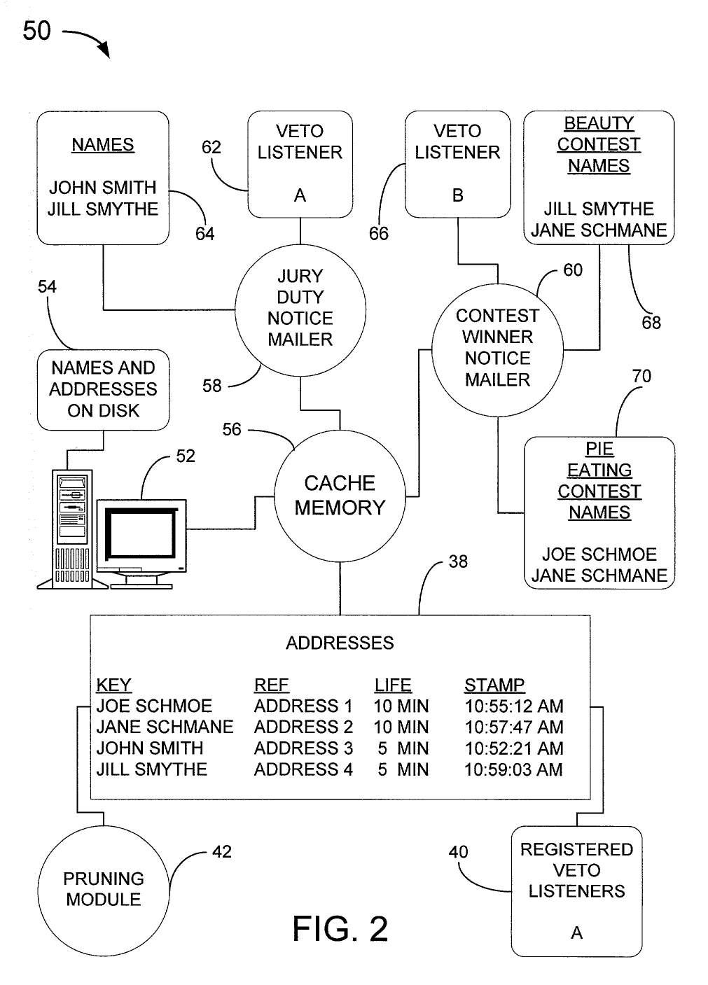

Referring to FIG. 2, a data access management system 50 is shown. A disk server 52 has names and addresses stored on disk as shown at 54. The cache memory 56 accessible to disk server 52 is further acceptable to a jury duty notice mailer application 58 and a contest winner notice mailer application 60. Jury duty notice mailer application 58, further features a veto listener A 62 and a list of names 64. Contest winner notice mailer 60 further features a veto listener B 66, a list of beauty contest names 68, and a list of pie eating contest names 70. Residing in the cache memory 56 is data structure 38. In accordance with one embodiment according to the present invention, data structure 38 features a list of registered listeners 40 and pruting module 42.

In its implementation with a data access management system 50, data structure 38 is organized into reference entries keyed by name containing references to addresses associated with those names. These reference entries also have associated lifetime and time stamp fields. As will readily be appreciated by those skilled in the art, associated addresses normally stored on disk may be more readily accessible in cache memory. Wherein the addresses reside as objects in the cache memory 56 with references pointing to those objects in a reference table comprised of data structure 38. As will readily be appreciated by those skilled in the art, it is possible for objects to be recast as a different type and even stored as primitives within the reference field of data structure 38. Thus, populating the reference fields of data structure 38 with string objects corresponding to information contained in the address objects is equally in accordance with various embodiments according to the present invention.

Still further in accordance with one embodiment according to the present invention, and especially in accordance with its implementation as a data access management system, jury duty notice mailer application 58 and contest winner notice mailer application 60 look up addresses in the data structure 38. According to their key lists containing names. If the applications do not find the keys in the data structure 38, they then access the names and addresses on disk via disk server 52 and enter the addresses as reference entries keyed by name in data structure 38. Associated lifetimes may be specified by the application based on the needs of the particular application set by default in the absence of a specified lifetime. Associated time stamps are initialized to a current time at time of initialization of the reference entry and reset to reflect the time of access each time a reference entry is accessed by an application. If desired, applications register their veto listeners with data structure 38 as previously described and deregister those listeners as appropriate. Thus, contest winner notice mailer application 60 may chose to veto an eminent removal of a reference entry originally initiated by jury duty notice mailer application 58 based on knowledge that it will soon traverse the same alphabetical region of names. Further, implementations of computer resource management with according to various embodiments of the present invention will be readily appreciated by those skilled in the art.

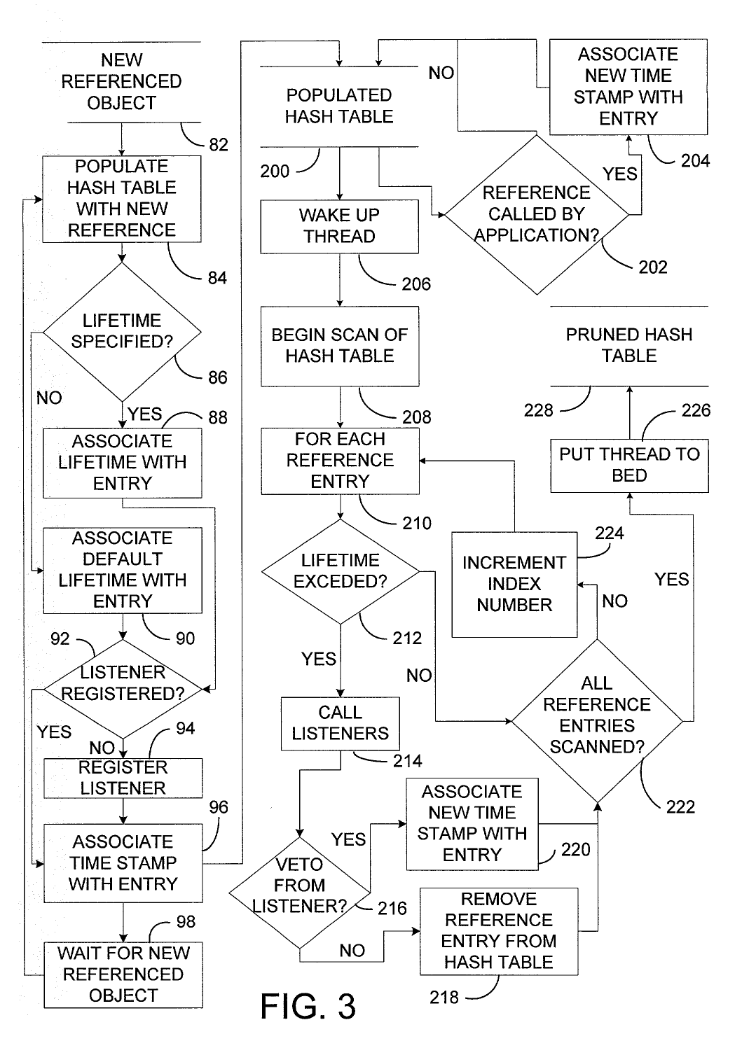

Referring to FIG. 3, an exemplary method of operation for use with one embodiment according to the present invention is shown. In accordance with the method, a new reference object is required by an application as shown at 82. As will readily be appreciated in view of the example implementations above, it is assumed that an application has attempted to reference the object via the data structure prior to presenting a new referenced object to the data structure. As previously noted, in one embodiment the data structure corresponds to a hash table, and the hash table is populated with new references as reference entries as at step 84. Depending on whether a lifetime is specified by the application as at 86 the lifetime is associated with the reference entry, as at step 88 or, alternatively, the default lifetime is associated with the reference entry as at step 90. Further depending on whether the application's listener is already registered with the hash table as at 92, the application's listener is registered with the hash table at step 94 and, in any case, the time stamp is associated with a reference entry reflecting the current time at step 96. This hash table population process is followed for each new referenced object as shown at step 98. The result is a populated hash table 200.

Depending on whether a reference entry is called by application as at 202, the time stamp associated with the reference entry is updated to reflect a current time as at step 204 each time the reference entry is called. Thus, populated hash table 200 contains reference entries with associated time stamps reflecting a time of last access regarding the reference entry.

Proceeding to step 206, the thread that prunes the hash table wakes up and begins the scan of the hash table at step 208. For each reference entry, as shown at 210, the pruning thread determines whether an associated lifetime has been exceeded as at 212. As will readily be appreciated by one skilled in the art, if an associated life time corresponds to an amount of time and a time stamp corresponds to a point in time, the process may include comparing the associated time stamp to a current time to arrive at an elapsed time and then comparing the elapsed time to the associated life time. Alternatively, if the associated lifetime is a future point in time that is updated each time the reference entry is called by an application as at 202, it may not be necessary to have a time stamp and the determination regarding whether the lifetime has been exceeded at 212 may involve comparing a current time to the associated lifetime. Further methods for determining whether a lifetime has been exceeded for a reference entry will be readily appreciated by one skilled in the art.

In the event that a lifetime has been determined to be exceeded, the pruning thread calls listeners registered with the hash table at step 214. Depending on whether the pruning thread receives a veto from a listener as at 216, the pruning thread either removes the reference entry from the hash table at step 218 or associates a new time stamp with the reference entry at step 220. As will be readily appreciated by one skilled in the art, the hash table may be designed to automatically update the time stamp associated with a reference entry coincident with scan by the pruning thread, and still remove the entry if a veto is not received from a client. In such a case, it is possible that a reference entry will be removed from the hash table after having received a new time stamp. Notably, however, the actions of the pruning tread are preferably synchronized to prevent referencing of the hash table by applications during the pruning process.

Depending on whether all reference entries in the hash table have been scanned by the pruning thread as at 222, an index number will be incremented as at step 224. The processing will continue until all reference entries in the hash table have been scanned. Once all reference entries have been scanned by the pruning thread, the thread goes back to sleep at step 226. Resulting in a pruned hash table 228

As will readily be appreciated by one skilled in the art, variations regarding the number of steps, order of steps, implementation of steps, and characterizations of steps may be accomplished that are further in accordance with one embodiment according to the present invention. The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A computer resource access system for use with a computer system, said system comprising:
a data structure residing in computer memory accessible to said computer system; and
a reference residing in said data structure as a reference entry, said reference providing access to a computer resource required by a computer application, said reference entry having an associated lifetime;
wherein said data structure is operable to remove the reference entry based on the associated lifetime.

2. The system of claim 1, wherein said reference entry has an associated time stamp, the associated time stamp indicating at least one of:
a) a time of initialization of the reference entry, and
b) a time of last access regarding the reference entry.

3. The system of claim 2, wherein said data structure is further operable to:
a) make an elapsed time determination based on a comparison of the associated time stamp to a current time,
b) make an expiration determination based on a comparison of the associated lifetime to the elapsed time, and
c) remove the reference entry from said data structure based on the expiration determination.

4. The system of claim 2, wherein said data structure is further operable to at least one of:
a) associate a time stamp reflecting the current time with the reference entry upon an initialization of the reference entry, and
b) update the time stamp to reflect the current time whenever the reference entry is accessed by the application.

5. The system of claim 1, wherein said data structure is further operable to:
a) register a listener of the application;
b) notify the listener of imminent removal of the reference entry; and
c) comply with a veto from the listener regarding removal of the reference entry.

6. The system of claim 1, wherein said data structure is further operable to at least one of:
a) associate a specified lifetime with the reference entry upon initialization of the reference entry, the specified lifetime specified by the application; and
b) associate a default lifetime with the reference entry upon initialization of the reference entry.

7. The system of claim 1, wherein the application is adapted to access the computer resource via said data structure.

8. The system of claim 1, wherein the application is adapted to specify the associated lifetime.

9. The system of claim 1, wherein the application is adapted:
a) to listen for an event indicating imminent removal of the reference entry from the data structure via a listener,
b) to request registration of the listener with the data structure, and
c) to communicate to the data structure a veto regarding removal of the reference entry from t he data structure.

10. A computer resource access method for use with a computer system, the method comprising:
populating a data structure with at least one reference as a reference entry, the data structure residing in memory accessible to said computer system, wherein the reference provides access to a computer resource of the computer system, and wherein the computer resource is required by a computer application; and
removing the reference entry based on an associated lifetime,
wherein the associated lifetime is associated with the reference entry.

11. The method of claim 10, wherein the reference entry has an associated time stamp, the associated time stamp indicating at least one of:
a) a time of initialization of the reference entry, and
b) a time of last access regarding the reference entry.

12. The method of claim 11, the method further comprising:
making an elapsed time determination based on a comparison of the associated time stamp to a current time,
making an expiration determination based on a comparison of the associated lifetime to the elapsed time, and
removing the reference entry from the data structure based on the expiration determination.

13. The method of claim 11, the method further comprising at least one of:
associating the time stamp with the reference entry at a time of initialization of the reference entry, the time stamp reflecting the time of the initialization, and
updating the time stamp upon a time of access of the reference entry to reflect the time of access.

14. The method of claim 10, the method further comprising:
registering a listener of the application;
notifying the listener of imminent removal of the reference entry; and
complying with a veto from the listener regarding removal of the reference entry.

15. The method of claim 10, the method further comprising at least one of:
associating a specified lifetime with the reference entry upon initialization of the reference entry, the specified lifetime specified by the application; and
associating a default lifetime with the reference entry upon initialization of the reference entry.

16. The method of claim 10, wherein the application is adapted to access the computer resource via the data structure.

17. The method of claim 10, wherein the application is adapted to specify the associated lifetime.

18. The method of claim 10, wherein the application is adapted:
a) to listen for an event indicating imminent removal of the reference entry from the data structure via a listener,
b) to request registration of the listener with the data structure, and
c) to communicate to the data structure a veto regarding removal of the reference entry from the data structure.

19. A data management system for use with a data structure stored in memory accessible to a data processing system, said system operable to:
traverse said data structure, said data structure organized into entries having associated lifetimes;
make an examination regarding the associated lifetimes; and
remove entries based on the examination.

20. The system of claim 19, wherein said data structure has registered listeners, said system further operable to:
notify said registered listeners regarding imminent removal of entries; and
comply with vetoes from said registered listeners regarding removal of entries.
